(19) United States
(12) Patent Application Publication
(10) Pub. No.: US 2020/0193808 A1
(43) Pub. Date: Jun. 18, 2020

(54) SYSTEMS AND METHODS FOR PROCESSING TRAFFIC OBJECTS

(71) Applicant: BEIJING DIDI INFINITY TECHNOLOGY AND DEVELOPMENT CO., LTD., Beijing (CN)

(72) Inventor: Jian GUAN, Beijing (CN)

(73) Assignee: BEIJING DIDI INFINITY TECHNOLOGY AND DEVELOPMENT CO., LTD., Beijing (CN)

(21) Appl. No.: 16/236,529

(22) Filed: Dec. 30, 2018

Related U.S. Application Data
(63) Continuation of application No. PCT/CN2018/122111, filed on Dec. 19, 2018.

(30) Foreign Application Priority Data
Dec. 18, 2018 (CN) 201811548552.0

(51) Int. Cl. G08G 1/01; H04L 29/08; H04L 12/861; G08G 1/052

(52) U.S. Cl. CPC G08G 1/0125; H04L 67/1097; H04L 67/12; G05D 1/0088; G08G 1/0112; G08G 1/052; H04L 49/90

(57) ABSTRACT

The present disclosure relates to systems and methods for processing traffic objects. The systems may receive detection information associated with a plurality of traffic objects within a predetermined range of a vehicle; extract feature values of a plurality of features of each of the plurality of traffic objects from the detection information; obtain a plurality of feature weights corresponding to the plurality of features of each traffic object; and determine a priority queue associated with the plurality of traffic objects based on a plurality of priority values, each corresponding to each traffic object, wherein the priority value is based on the plurality of feature weights and the feature values of each traffic object.

### CROSS-REFERENCE TO RELATED APPLICATIONS

This application is a continuation of International Application No. PCT/CN2018/122111 filed on Dec. 19, 2018 which designates the United States of America and claims priority to Chinese Patent Application No. 201811548552.0 filed on Dec. 18, 2018, the contents of which are incorporated herein by reference in their entirety.

### TECHNICAL FIELD

The present disclosure generally relates to systems and methods for processing traffic objects, and in particular, to systems and methods for determining processing priorities of traffic objects, thus facilitating autonomous driving.

### BACKGROUND

With the development of micro-electronic and robotic technologies, the exploration of autonomous driving has developed rapidly nowadays. Commonly, an autonomous driving system can obtain driving information (e.g., velocity, acceleration) associated with traffic objects within a predetermined distance range of a vehicle designed for autonomous driving, process the driving information associated with the traffic objects, and plan a driving path for the vehicle based on the processing results. Since the autonomous driving system requires rapid calculation and prompt reaction, the processing of the traffic objects should be kept within a certain limited time period. The existing systems, however, usually process the traffic objects indiscriminately or randomly, without considering the importance of each traffic object and the possible damages it can cause. Such an approach is time consuming and largely ineffectively. Therefore, it is desirable to provide systems and methods for setting priorities for the traffic objects and processing the traffic objects based on the priorities, thereby improving performance of the autonomous driving system.

### SUMMARY

An aspect of the present disclosure relates to a system for processing traffic objects. The system may include at least one storage medium including a set of instructions and at least one processor in communication with the at least one storage medium. When executing the set of instructions, the at least one processor may be directed to cause the system to perform one or more of the following operations. The system may receive detection information associated with a plurality of traffic objects within a predetermined range of a vehicle. The system may extract feature values of a plurality of features of each of the plurality of traffic objects from the detection information. The system may obtain a plurality of feature weights corresponding to the plurality of features of each traffic object. The system may determine a priority queue associated with the plurality of traffic objects based on a plurality of priority values, each corresponding to each traffic object, wherein the priority value is based on the plurality of feature weights and the feature values of each traffic object.

In some embodiments, the plurality of features of each of the plurality of traffic objects may include a type of the traffic object, a position of the traffic object, a velocity of the traffic object, an acceleration of the traffic object, and/or a distance between the traffic object and the vehicle.

In some embodiments, the system may process the plurality of traffic objects based on the priority queue.

In some embodiments, the plurality of feature weights may be based at least in part on a predetermined rule, statistical data, or machine learning.

In some embodiments, the plurality of feature weights may be adjusted based on test data.

In some embodiments, the plurality of feature weights corresponding to the plurality of features may be associated with traffic information, environmental information, time information, geographical information, or any combination thereof.

In some embodiments, the system may process at least part of the plurality of traffic objects one by one according to the priority queue within a predetermined processing time period.

In some embodiments, the system may select at least part of the plurality of traffic objects based on the priority queue. The system may process the at least part of the plurality of traffic objects in a parallel mode or a distributed mode within a predetermined processing time period.

In some embodiments, the system may obtain traffic conditions associated with the predetermined range of the vehicle. The system may predict probable behaviors associated with at least part of the plurality of traffic objects based on features of the at least part of the plurality of traffic objects and the traffic conditions. The system may determine a driving path for the vehicle based on the probable behaviors associated with the at least part of the plurality of traffic objects.

In some embodiments, the system may transmit signals to one or more control components of the vehicle to direct the vehicle to follow the driving path.

Another aspect of the present disclosure relates to a method implemented on a computing device. The computing device may include at least one processor, at least one storage medium, and a communication platform connected to a network. The method may include receiving detection information associated with a plurality of traffic objects within a predetermined range of a vehicle; extracting feature values of a plurality of features of each of the plurality of traffic objects from the detection information; obtaining a plurality of feature weights corresponding to the plurality of features of each traffic object; and determining a priority queue associated with the plurality of traffic objects based on a plurality of priority values, each corresponding to each traffic object, wherein the priority value is based on the plurality of feature weights and the feature values of each traffic object.

In some embodiments, the plurality of features of each of the plurality of traffic objects may include a type of the traffic object, a position of the traffic object, a velocity of the traffic object, an acceleration of the traffic object, and a distance between the traffic object and the vehicle.

In some embodiments, the method may further include processing the plurality of traffic objects based on the priority queue.

In some embodiments, the plurality of feature weights may be based at least in part on a predetermined rule, statistical data, or machine learning.

In some embodiments, the plurality of feature weights may be adjusted based on test data.

In some embodiments, the plurality of feature weights corresponding to the plurality of features may be associated with traffic information, environmental information, time information, geographical information, or any combination thereof.

In some embodiments, the processing of the plurality of traffic objects based on the priority queue may include processing at least part of the plurality of traffic objects one by one according to the priority queue within a predetermined processing time period.

In some embodiments, the processing of the plurality of traffic objects based on the priority queue may include selecting at least part of the plurality of traffic objects based on the priority queue; and processing the at least part of the plurality of traffic objects in a parallel mode or a distributed mode within a predetermined processing time period.

In some embodiments, the method may further include obtaining traffic conditions associated with the predetermined range of the vehicle; predicting probable behaviors associated with at least part of the plurality of traffic objects based on features of the at least part of the plurality of traffic objects and the traffic conditions; and determining a driving path for the vehicle based on the probable behaviors associated with the at least part of the plurality of traffic objects.

In some embodiments, the method may further include transmitting signals to one or more control components of the vehicle to direct the vehicle to follow the driving path.

A further aspect of the present disclosure relates to a non-transitory computer readable medium. The non-transitory computer readable medium may include executable instructions. When the executable instructions are executed by at least one processor, the executable instructions direct the at least one processor to perform a method. The method may include receiving detection information associated with a plurality of traffic objects within a predetermined range of a vehicle; extracting feature values of a plurality of features of each of the plurality of traffic objects from the detection information; obtaining a plurality of feature weights corresponding to the plurality of features of each traffic object; and determining a priority queue associated with the plurality of traffic objects based on a plurality of priority values, each corresponding to each traffic object, wherein the priority value is based on the plurality of feature weights and the feature values of each traffic object.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary autonomous driving system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating an exemplary processing engine according to some embodiments of the present disclosure;

FIG. 4 is a flowchart illustrating an exemplary process for determining a priority queue associated with traffic objects according to some embodiments of the present disclosure;

FIG. 5 is a schematic diagram illustrating an exemplary relation between a velocity of the vehicle and a velocity of a traffic object according to some embodiments of the present disclosure;

FIG. 6 is a flowchart illustrating an exemplary process for determining a driving path according to some embodiments of the present disclosure;

FIG. 7 is a schematic diagram illustrating an exemplary process for processing a plurality of traffic objects based on a priority queue according to some embodiments of the present disclosure; and

FIG. 8 is a schematic diagram illustrating an exemplary process for processing a plurality of traffic objects based on a priority queue in a parallel mode according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding a transportation system in land, it should be understood that this is only one exemplary embodiment. The systems and methods of the present disclosure may be applied to any other kind of transportation system. For example, the systems and methods of the present disclosure may be applied to transportation systems of different environments including ocean, aerospace, or the like, or any combination thereof. The vehicle of the transportation systems may include a car, a bus, a train, a subway, a vessel, an aircraft, a spaceship, a hot-air balloon, or the like, or any combination thereof.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for determining a priority queue associated with a plurality of traffic objects within a predetermined range of a vehicle. According to some systems and methods of the present disclosure, a processor may receive detection information associated with the plurality of traffic objects, extract feature values of a plurality of features of each of the plurality of traffic objects from the detection information, obtain a plurality of feature weights corresponding to the plurality of features of each traffic object, and determine the priority queue associated with the plurality of traffic objects based on a plurality of priority values, wherein each priority value corresponds to each traffic object, and the priority value may be based on the plurality of feature weights and the feature values of each traffic object. Furthermore, according to some systems and methods of the present disclosure, the processor may further process the plurality of traffic objects (e.g., predict probable behaviors) based on the priority queue and determine a driving path for the vehicle based on processing results. According to the systems and methods of the present disclosure, the plurality of traffic objects are processed based on a priority queue, which can ensure that traffic object(s) with relatively high importance degree to the driving of the vehicle can be processed timely, thereby improving the accuracy of the path planning for the vehicle.

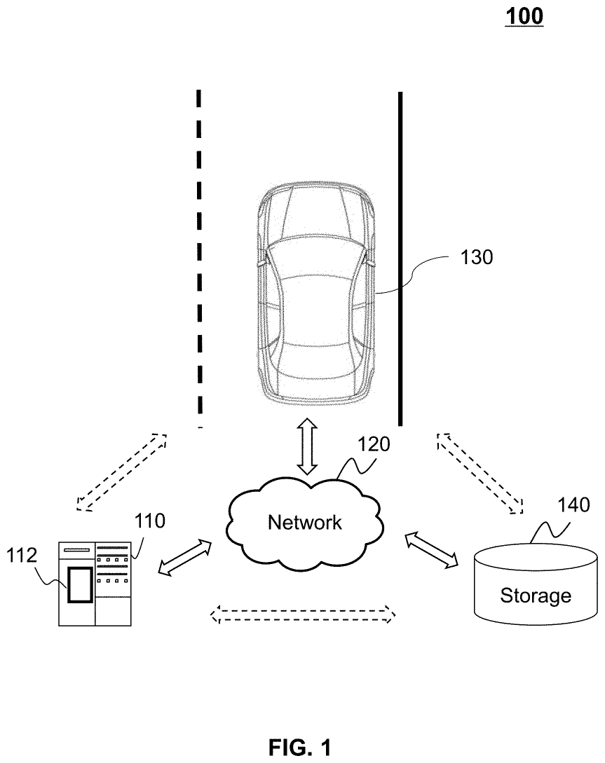

FIG. 1 is a schematic diagram illustrating an exemplary autonomous driving system according to some embodiments of the present disclosure. In some embodiments, the autonomous driving system 100 may include a server 110, a network 120, a vehicle 130, and a storage 140.

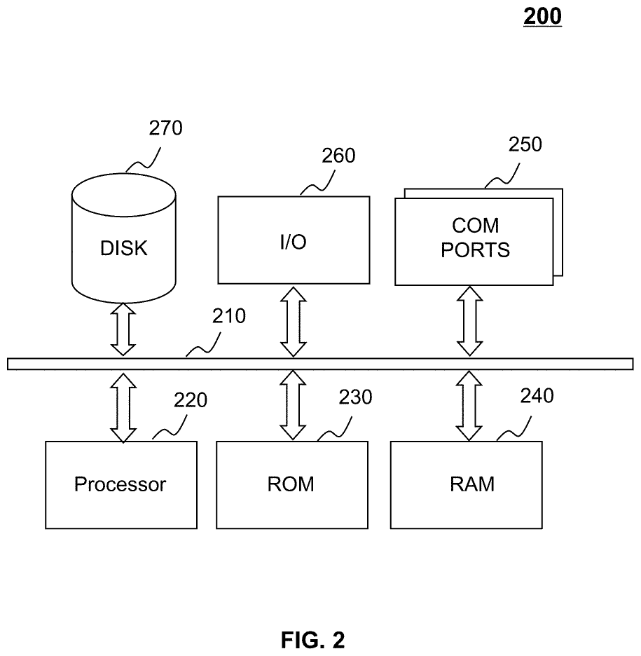

In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the vehicle 130 and/or the storage 140 via the network 120. As another example, the server 110 may be directly connected to the vehicle 130 and/or the storage 140 to access stored information and/or data. In some embodiments, the server 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 in the present disclosure.

In some embodiments, the server 110 may include a processing engine 112. The processing engine 112 may process information and/or data associated with driving information associated with the vehicle 130 to perform one or more functions described in the present disclosure. For example, the processing engine 112 may obtain detection information associated with a plurality of traffic objects within a predetermined range of the vehicle 130 and determine a priority queue associated with the plurality of traffic objects based on the detection information. Further, the processing engine 112 may process the plurality of traffic objects based on the priority queue. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 110 may be connected to the network 120 to communicate with one or more components (e.g., the vehicle 130, the storage 140) of the autonomous driving system 100. In some embodiments, the server 110 may be directly connected to or communicate with one or more components (e.g., the vehicle 130, the storage 140) of the autonomous driving system 100. In some embodiments, the server 110 may be integrated in the vehicle 130. For example, the server 110 may be a computing device (e.g., an on-board computer) installed in the vehicle 130.

The network 120 may facilitate exchange of information and/or data. In some embodiments, one or more components (e.g., the server 110, the vehicle 130, or the storage 140) of the autonomous driving system 100 may send information and/or data to other component(s) of the autonomous driving system 100 via the network 120. For example, the server 110 may obtain detection information associated with a plurality of traffic objects within a predetermined range of the vehicle 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points, through which one or more components of the autonomous driving system 100 may be connected to the network 120 to exchange data and/or information.

The vehicle 130 may be any type of autonomous vehicle. The autonomous vehicle may be capable of sensing environmental information and navigating without human maneuvering. The vehicle 130 may include structures of a conventional vehicle. For example, the vehicle 130 may include a plurality of control components configured to control operations of the vehicle 130. The plurality of control components may include a steering device (e.g., a steering wheel), a brake device (e.g., a brake pedal), an accelerator, etc. The steering device may be configured to adjust a heading and/or a direction of the vehicle 130. The brake device may be configured to perform a braking operation to stop the vehicle 130. The accelerator may be configured to control a velocity and/or an acceleration of the vehicle 130.

The vehicle 130 may also include a plurality of detection units configured to detect driving information associated with the vehicle 130. The plurality of detection units may include a camera, a global position system (GPS) module, an acceleration sensor (e.g., a piezoelectric sensor), a velocity sensor (e.g., a Hall sensor), a distance sensor (e.g., a radar, a LIDAR, an infrared sensor), a steering angle sensor (e.g., a tilt sensor), a traction-related sensor (e.g., a force sensor), etc. In some embodiments, the driving information associated with the vehicle 130 may include detection information associated with a plurality of traffic objects (e.g., a pedestrian, a vehicle) within a predetermined range of the vehicle 130, road condition information within the predetermined range of the vehicle 130, map information within the predetermined range of the vehicle 130, etc.

The storage 140 may store data and/or instructions. In some embodiments, the storage 140 may store data obtained from the vehicle 130, such as driving information associated with the vehicle 130 acquired by the plurality of detection units. In some embodiments, the storage 140 may store data and/or instructions that the server 110 may execute or use to perform exemplary methods described in the present disclosure. In some embodiments, the storage 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 140 may be connected to the network 120 to communicate with one or more components (e.g., the server 110, the vehicle 130) of the autonomous driving system 100. One or more components of the autonomous driving system 100 may access the data or instructions stored in the storage 140 via the network 120. In some embodiments, the storage 140 may be directly connected to or communicate with one or more components (e.g., the server 110, the vehicle 130) of the autonomous driving system 100. In some embodiments, the storage 140 may be part of the server 110. In some embodiments, the storage 140 may be integrated in the vehicle 130.

It should be noted that the autonomous driving system 100 is merely provided for the purposes of illustration, and is not intended to limit the scope of the present disclosure. For persons having ordinary skills in the art, multiple variations or modifications may be made under the teachings of the present disclosure. For example, the autonomous driving system 100 may further include a database, an information source, etc. As another example, the autonomous driving system 100 may be implemented on other devices to realize similar or different functions. However, those variations and modifications do not depart from the scope of the present disclosure.

FIG. 2 is a schematic diagram illustrating exemplary hardware and/or software components of an exemplary computing device according to some embodiments of the present disclosure. In some embodiments, the server 110 may be implemented on the computing device 200. For example, the processing engine 112 may be implemented on the computing device 200 and configured to perform functions of the processing engine 112 disclosed in this disclosure.

The computing device 200 may be used to implement any component of the autonomous driving system 100 of the present disclosure. For example, the processing engine 112 of the autonomous driving system 100 may be implemented on the computing device 200, via its hardware, software program, firmware, or a combination thereof. Although only one such computer is shown for convenience, the computer functions associated with the autonomous driving system 100 as described herein may be implemented in a distributed manner on a number of similar platforms to distribute the processing load.

The computing device 200, for example, may include communication (COMM) ports 250 connected to and from a network (e.g., the network 120) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read only memory (ROM) 230, or a random access memory (RAM) 240, for storing various data files to be processed and/or transmitted by the computing device 200. The computing device 200 may also include program instructions stored in the ROM 230, the RAM 240, and/or other type of non-transitory storage medium to be executed by the processor 220. The methods and/or processes of the present disclosure may be implemented as the program instructions. The computing device 200 also includes an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As in another example, operation A and operation B may also be performed by two different processors jointly or separately in the computing device 200 (e.g., the first processor executes operation A and the second processor executes operation B, or the first and second processors jointly execute operations A and B).

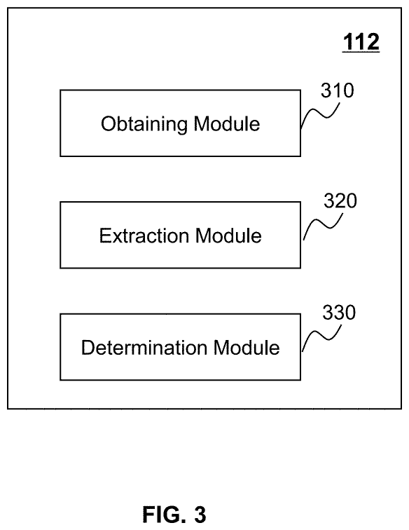

FIG. 3 is a block diagram illustrating an exemplary processing engine according to some embodiments of the present disclosure. The processing engine 112 may include an obtaining module 310, an exaction module 320, and a determination module 330.

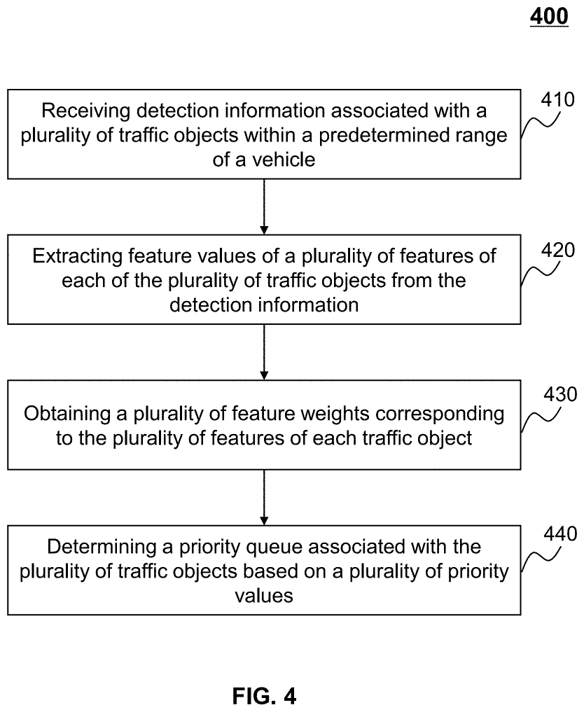

The obtaining module 310 may be configured to receive detection information associated with a plurality of traffic objects within a predetermined range of a vehicle (e.g., the vehicle 130). A traffic object may be any object that may affect the movement, speed, path, and/or safety of the vehicle due to the object's position, movement, size, and/or other features, as well as other parameters such as traffic conditions or weather conditions. The obtaining module 310 may receive the detection information associated with the plurality of traffic objects from the detection units (e.g., a camera, a radar) of the vehicle or a storage device (e.g., the storage 140) disclosed elsewhere in the present disclosure. In some embodiments, the plurality of traffic objects may include a vehicle (e.g., a car, a bus, a truck, a motorcycle, a bicycle), a pedestrian, an animal, a roadblock, a tree, a building, a street light, a pole, etc. In some embodiments, the predetermined range may be default settings of the autonomous driving system 100 or may be adjustable under different situations. More descriptions of the detection information associated with the plurality of traffic objects may be found elsewhere in the present disclosure (e.g., FIG. 4 and the descriptions thereof).

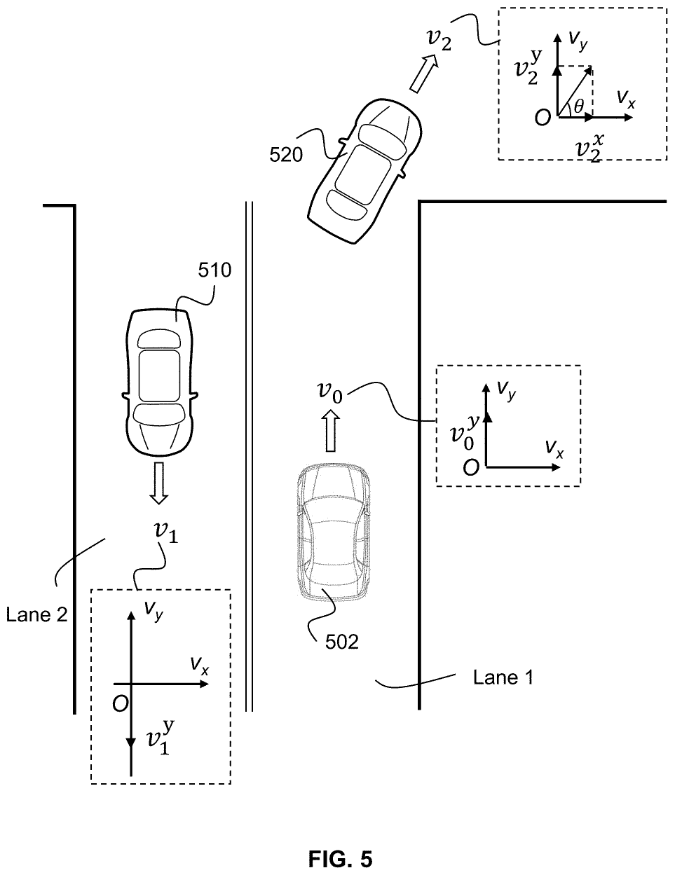

The exaction module 320 may be configured to extract feature values of a plurality of features of each of the plurality of traffic objects from the detection information. In some embodiments, the plurality of features of each of the plurality of traffic objects may include a type (e.g., pedestrian, vehicle, motorcycle, bicycle) of the traffic object, a position of the traffic object, a velocity of the traffic object, an acceleration of the traffic object, a distance (e.g., a linear distance, a road distance) between the traffic object and the vehicle, etc. More descriptions of the feature values and/or the features may be found elsewhere in the present disclosure (e.g., FIGS. 4-5 and the descriptions thereof).

The determination module 330 may be configured to obtain a plurality of feature weights corresponding to the plurality of features of each traffic object. In some embodiments, the plurality of feature weights corresponding to the plurality of features of each traffic object may be determined based on one or more predetermined rules, statistical data, and/or machine learning. In some embodiments, the plurality of feature weights corresponding to the plurality of features may be associated with traffic information, environmental information, time information, geographical information, or the like, or any combination thereof. More descriptions of the feature weights may be found elsewhere in the present disclosure (e.g., FIG. 4 and the descriptions thereof).

The determination module 330 may further be configured to determine a priority queue associated with the plurality of traffic objects based on a plurality of priority values, wherein the priority value is based on the plurality of feature weights and the feature values of each traffic object. In some embodiments, the determination module 330 may determine the priority queue based on the plurality of priority values corresponding to the plurality of traffic objects according to a predetermined order (e.g., an ascending order, a descending order).

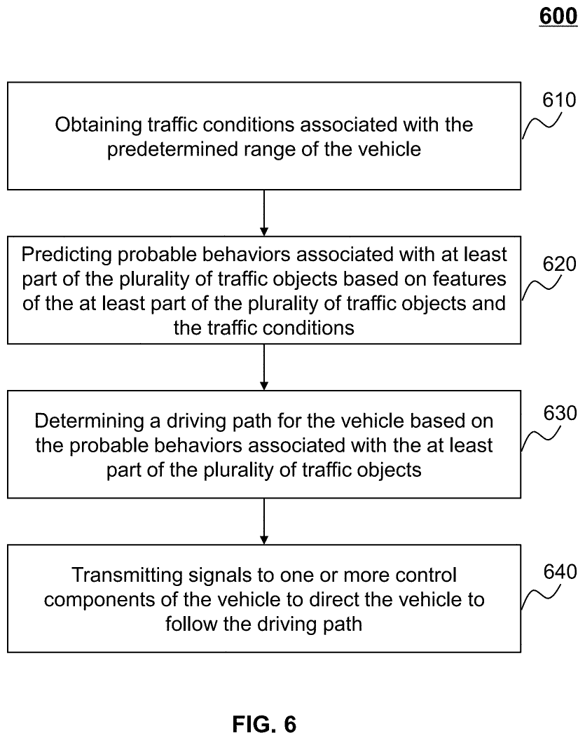

In some embodiments, the processing engine 112 may further include a processing module (not shown). The processing module may be configured to process the plurality of traffic objects based on the priority queue. In some embodiments, the processing module may process at least part of the plurality of traffic objects one by one according to the priority queue within a predetermined processing time period. In some embodiments, the processing module may process at least part of the plurality of traffic objects in a parallel mode or a distributed mode according to the priority queue within the predetermined processing time period. In some embodiments, the processing module may predict probable behaviors associated with the at least part of the plurality of traffic objects based on features of the at least part of the plurality of traffic objects and the traffic conditions. More descriptions of the processing of the plurality of traffic objects may be found elsewhere in the present disclosure (e.g., FIG. 4, FIGS. 6-8, and the descriptions thereof).

In some embodiments, the processing engine 112 may further include a driving path determination module (not shown). The driving path determination module may be configured to determine a driving path for the vehicle based on the processing results (e.g., the predicted probable behaviors). In some embodiments, the processing engine 112 may further include a transmission module (not shown). The transmission module may be configured to transmit signals to one or more control components of the vehicle to direct the vehicle to follow the driving path.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the modules may be combined as a single module, any one of the modules may be divided into two or more units.

For example, the obtaining module 310 and the extraction module 320 may be combined as a single module which may both receive the detection information associated with the plurality of traffic objects and extract feature values of a plurality of features of each traffic object. As another example, the determination module 330 may be divided into two units including a feature weight determination unit and a priority queue determination unit, wherein the feature weight determination unit may be configured to obtain the plurality of feature weights corresponding to the plurality of features of each traffic object and the priority queue determination unit may be configured to determine the priority queue based on a plurality of priority values corresponding to the plurality of features. As a further example, the processing engine 112 may include a storage module (not shown) which may be configured to store information and/or data (e.g., the detection information, the feature values, the priority values, the priority queue) associated with the plurality of traffic objects.

FIG. 4 is a flowchart illustrating an exemplary process for determining a priority queue associated with a plurality of traffic objects according to some embodiments of the present disclosure. The process 400 may be executed by the autonomous driving system 100. For example, the process 400 may be implemented as a set of instructions stored in the storage ROM 230 or RAM 240. The processor 220 and/or the modules in FIG. 3 may execute the set of instructions, and when executing the instructions, the processor 220 and/or the modules may be configured to perform the process 400. The operations of the illustrated process presented below are intended to be illustrative. In some embodiments, the process 400 may be accomplished with one or more additional operations not described and/or without one or more of the operations discussed. Additionally, the order in which the operations of the process 400 illustrated in FIG. 4 and described below is not intended to be limiting.

In 410, the processing engine 112 (e.g., the obtaining module 310) (e.g., the interface circuits of the processor 220) may receive detection information associated with a plurality of traffic objects within a predetermined range of a vehicle (e.g., the vehicle 130). The processing engine 112 may receive the detection information associated with the plurality of traffic objects from the detection units (e.g., a camera, a radar) of the vehicle or a storage device (e.g., the storage 140) disclosed elsewhere in the present disclosure. A traffic object may be any object that may affect the movement, speed, path, and/or safety of the vehicle due to the object's position, movement, size, and/or other features, as well as other parameters such as traffic conditions or weather conditions. In some embodiments, the plurality of traffic objects may include a vehicle (e.g., a car, a bus, a truck, a motorcycle, a bicycle), a pedestrian, an animal, a roadblock, a tree, a building, a street light, a pole, etc.

In some embodiments, the predetermined range may be a default setting of the autonomous driving system 100 or may be adjustable under different situations. For example, the predetermined range may be a region in front of the vehicle, e.g., a fan-shaped region, a semi-circle region, or a circle region with a current location of the vehicle as a center and a perception distance or part of the perception distance of the vehicle as a radius. As used herein, the perception distance refers to a longest detectable distance of the detection units of the vehicle. In some embodiments, only a part of the perception distance is incorporated into the predetermined range, allowing a more flexible approach and adjustment of the range by changing the percentage of the perception distance being used. As another example, the predetermined range may be a region in front of the vehicle, for example, a triangle region with the current location of the vehicle as a vertex and the perception distance of the vehicle as a side length. As a further example, the predetermined range may be a region in front of the vehicle, for example, a square or a rectangle region with the current location of the vehicle as a side center and the perception distance of the vehicle as a side length. As still a further example, the predetermined range may be any region (e.g., a circle, a rectangle, a square, a triangle, a polygon) including the current location of the vehicle.

In 420, the processing engine 112 (e.g., the exaction module 320) (e.g., the processing circuits of the processor 220) may extract feature values of a plurality of features of each of the plurality of traffic objects from the detection information.

In some embodiments, the plurality of features of each of the plurality of traffic objects may include a type (e.g., pedestrian, vehicle, motorcycle, bicycle) of the traffic object, a position (e.g., crossing, lane, sidewalk) of the traffic object, a velocity of the traffic object, an acceleration of the traffic object, a distance (e.g., a linear distance, a road distance) between the traffic object and the vehicle, etc. As used herein, the “velocity” includes “magnitude” information and/or “direction” information. For example, the velocity of the traffic object may be expressed as “70 km/h, 30°” which indicates that the magnitude of the velocity is 70 km/h and the direction of the velocity is a direction with a 30° angle from the horizontal direction (i.e., x-axis). Similarly, the “acceleration” also includes “magnitude” information and/or “direction” information.

In some embodiments, for a specific feature, a corresponding feature value may be a mathematical expression (e.g., a value, a vector, a matrix, a determinant) associated with the specific feature.

For example, for the feature “type of the traffic object,” a corresponding feature value may be expressed as a first vector illustrated below:

V_{T}=(P,V,C,M) (1)

where V_{T} refers to the first vector representing the feature value of the “type of the traffic object,” P refers to “pedestrian,” V refers to “vehicle,” C refers to “bicycle,” and M refers to “motorcycle.” For example, a feature value of a “pedestrian” type is (1, 0, 0, 0).

As another example, for the feature “position of the traffic object,” a corresponding feature value may be expressed as a second vector illustrated below:

V_{P}=(c,l,s) (2)

where V_{P} refers to the second vector representing the feature value of the “position of the traffic object,” c refers to a position “crossing,” l refers to a position “lane,” and s refers to a position “sidewalk.” For example, a feature value of the position “lane” is (0, 1, 0).

As a further example, for the feature “distance between the traffic object and the vehicle,” the processing engine 112 may determine a corresponding feature value according to formula (3) below:

$${V}_{D} = \frac{D}{{D}_{P}} \qquad ( 3 )$$

where V_{D} refers to the feature value of the “distance between the traffic object and the vehicle,” D refers to an actual value of the distance between the traffic object and the vehicle, and D_{P} refers to the perception distance of the detection units of the vehicle. It can be seen that the feature value of the “distance between the traffic object and the vehicle” is a normalized value based on the perception distance. It should be noted that the feature value also can be the actual value (i.e., D) of the distance between the traffic object and the vehicle or any modified value associated with the actual value of the distance.

As still a further example, as described above, the “velocity” includes “direction information,” accordingly, the “velocity of the traffic object” can be decomposed into an “x-axis velocity of the traffic object” and a “y-axis velocity of the traffic object.” Further, the processing engine 112 may determine respective feature values of the “x-axis velocity of the traffic object” and the “y-axis velocity of the traffic object” according to formula (4) and formula (5) below:

V₁=|vₜ^{x}−v₀^{x}| (4)

V₂=|vₜ^{y}−v₀^{y}| (5)

where V₁ refers to an absolute value of the feature value (also referred to as a “first feature value”) of the “x-axis velocity of the traffic object,” V₂ refers to an absolute value of the feature value (also referred to as a “second feature value”) of the “y-axis velocity of the traffic object,” vₜ^{x} refers to a value of the x-axis velocity of the traffic object, v₀^{x} refers to a value of an x-axis velocity of the vehicle, vₜ^{y} refers to a value of the y-axis velocity of the traffic object, and v₀^{y} refers to a value of a y-axis velocity of the vehicle.

In some embodiments, take the “x-axis velocity of the traffic object” as an example, in response to the determination that a direction of the x-axis velocity of the traffic object and a direction of the x-axis velocity of the vehicle are the same (e.g., both along positive x-axis direction) and an absolute value of the x-axis velocity of the traffic object is less than an absolute value of the x-axis velocity of the vehicle (i.e., |vₜ^{x}|≤|v₀^{x}|), or in response to the determination that the direction of the x-axis velocity of the traffic object and the direction of the x-axis velocity of the vehicle are different, the processing engine 112 may determine the first feature value as positive; whereas, in response to the determination that the direction of the x-axis velocity of the traffic object and the direction of the x-axis velocity of the vehicle are the same (e.g., both along positive x-axis direction) and the absolute value of the x-axis velocity of the traffic object is higher than the absolute value of an x-axis velocity of the vehicle (i.e., |vₜ^{x}|>|v₀^{x}|), the processing engine 112 may determine the first feature value as negative. It should be noted that if the x-axis velocity is 0, it can be considered as along positive x-axis direction or negative x-axis direction.

In some embodiments, the processing engine 112 may also determine a comprehensive feature value (e.g., a sum, an average, a weighted average) of the “velocity of the traffic object” based on the first feature value and the second feature value.

As still a further example, the “acceleration” also includes “direction information,” the processing engine 112 may accordingly determine respective feature values of an “x-axis acceleration of the traffic object” and a “y-axis acceleration of the traffic object” as described in connection with above.

In 430, the processing engine 112 (e.g., the determination module 330) (e.g., the processing circuits of the processor 220) may obtain a plurality of feature weights corresponding to the plurality of features of each traffic object. As used herein, for a specific feature, a feature weight may be any mathematical expression associated with the specific feature, which indicates an importance degree of the specific feature to the driving process of the vehicle.

In some embodiments, the plurality of feature weights corresponding to the plurality of features of each traffic object may be determined based on one or more predetermined rules. The predetermined rules may be default settings of the autonomous driving system 100 or may be adjustable under different situations.

For example, for the “type of the traffic object,” the feature weight may be expressed as a third vector illustrated below:

$${W}^{type} = ( \begin{matrix}0.4 \\ 0.3 \\ 0.15 \\ 0.15\end{matrix} ) \qquad ( 6 )$$

As described in connection with operation 420, according to the first vector and the third vector, it can be seen that the “pedestrian” is assigned a relatively high importance degree.

As another example, for the “position of the traffic object,” the feature weight may be expressed as a fourth vector illustrated below:

$${W}^{position} = ( \begin{matrix}0.5 \\ 0.4 \\ 0.1\end{matrix} ) \qquad ( 7 )$$

As described in connection with operation 420, according to the second vector and the fourth vector, it can be seen that the “crossing” is assigned a relatively high importance degree.

As a further example, the feature weight of the “distance between the traffic object and the vehicle” may be a negative constant. As still a further example, the feature weight (also referred to as a “first feature weight”) of the “x-axis-velocity of the traffic object” and/or the feature weight (also referred to as a “second feature weight”) of the “y-axis-velocity of the traffic object” may be positive constants, wherein the first feature weight may be the same as or different from the second feature weight.

In some embodiments, the plurality of feature weights corresponding to the plurality of features may be associated with traffic information, environmental information, time information, geographical information, or the like, or any combination thereof.

The traffic information may indicate congestion information associated with the predetermined range of the vehicle. In some embodiments, the processing engine 112 may obtain the traffic information from the storage 140 or an external data resource (e.g., a map service resource). In some embodiments, the congestion information may be expressed as one of a plurality of congestion levels based on traffic flow within the predetermined range of the vehicle, for example “heavy congestion,” “normal congestion,” “mid congestion,” “smooth traffic” illustrated in Table 1 below.

TABLE 1
exemplary congestion levels

| Congestion Level | Traffic Flow | Level Value |
|---|---|---|
| heavy congestion | F < a | 4 |
| normal congestion | A ≤ F < b | 3 |
| mild congestion | B ≤ F < c | 2 |
| smooth traffic | F ≥ c | 1 |

As shown in Table 1, each of parameters “a,” “b,” and “c” refers to a traffic flow threshold, and F refers to a traffic flow of a specific location point within the predetermined range of the vehicle. The traffic flow thresholds may be default settings of the autonomous driving system 100 or may be adjustable under different situations (e.g., the traffic flow thresholds may be different for different cities).

In some embodiments, the processing engine 112 may determine the plurality of feature weights based on the traffic information. For example, the higher the congestion level associated with the predetermined range of the vehicle is, the higher an absolute value of the feature weight of the “distance between the traffic object and the vehicle” may be, and the higher the feature weight of the “x-axis velocity of the traffic object” and/or the feature weight of the “y-axis velocity of the traffic object” may be.

The environmental information may include weather information associated with the predetermined range of the vehicle. In some embodiments, the processing engine 112 may obtain the environmental information from the storage 140 or an external data resource (e.g., a weather broadcast resource). In some embodiments, the weather information may be expressed as one of a plurality of weather conditions, for example, “rainy,” “snowy,” “sunny,” “foggy,” etc.

In some embodiments, the processing engine 112 may determine the plurality of feature weights based on the environmental information. For example, it is assumed that the environmental information indicates that it is foggy, the feature weight of the “x-axis-velocity of the traffic object” and/or the feature weight of the “y-axis-velocity of the traffic object” may be set as a relatively high value, the absolute value of the feature weight of the “distance between the traffic object and the vehicle” may also be set as a relatively high value; whereas, it is assumed that the environmental information indicates that it is sunny, the feature weight(s) may be set as a relatively low value.

The time information may be expressed as one of a plurality of time periods based on possible traffic demands, for example, “morning peak time period” which corresponds to 7:00 a.m.˜9:00 a.m., “evening peak time period” which corresponds to 5:30 p.m.˜8:00 p.m., “working time” which corresponds to 9:00 a.m.˜5:30 p.m., “night time” which corresponds to 8:00 p.m.˜7:00 a.m., etc. For the “morning peak time period” and “evening peak time period,” the traffic demand may be relatively high; for the “working time,” the traffic demand may be medium; and for the “night time,” the traffic demand may be relatively low.

In some embodiments, the processing engine 112 may determine the plurality of feature weights based on the time information. For example, it is assumed that the time information indicates that it is morning peak time period, the feature weight of the “type of the traffic object” may be set as a vector according to which a higher importance degree may be assigned to “vehicle.”

The geographical information may be expressed as one of a plurality of geographical categories based on possible traffic demands and/or pedestrian volumes, for example, “business district,” “office area,” “residential area,” “village,” etc. For example, the traffic demand and/or the pedestrian volume in the “business district” may be relatively high.

In some embodiments, the processing engine 112 may determine the plurality of feature weights based on the geographical information. For example, it is assumed that the geographical information indicates the vehicle is located in a business district, the feature weight of the “position of the traffic object” may be set as a vector according to which a higher importance degree may be assigned to “sidewalk.”

It should be noted that the above examples are provided for illustration purposes, in practical applications, while determining the plurality of feature weights corresponding to the plurality of features, the above information will be comprehensively considered. For example, it is assumed that a scenario may be “in a rainy day, the vehicle is located in an office area at morning peak time period and the congestion level is ‘heavy congestion,” the processing engine 112 may determine suitable feature weights corresponding to the plurality of features with the above information comprehensively taken into consideration by using any suitable algorithm or model.

In some embodiments, the plurality of feature weights corresponding to the plurality of features of each traffic object may be determined based on statistical data. For example, the processing engine 112 may obtain historical feature weights corresponding to the plurality of features, evaluate effectiveness of the historical feature weights, and determine modified feature weights based on the effectiveness. As used herein, take a specific historical feature weight as an example, the effectiveness of may be evaluated based on one or more features (e.g., smoothness, a distance between the historical driving path and a nearest historical traffic object) associated with a historical driving path of the vehicle which is determined based on the specific historical feature weight.

In some embodiments, the plurality of feature weights corresponding to the plurality of features of each traffic object may be determined based on machine learning. In some embodiments, the processing engine 112 may obtain a plurality of samples by simulating operation of the vehicle based on one or more features (e.g., vehicle type, vehicle weight, vehicle model) of the vehicle under different driving scenarios. As used herein, each driving scenario may correspond to various traffic information, environmental information, time information, geographical information, or the like, or any combination thereof. Each of the plurality of samples may correspond to a simulated ideal driving path of the vehicle and a plurality of simulated traffic objects within the predetermined range of the vehicle. As used herein, the simulated ideal driving path of the vehicle may refer to a driving path which is determined based on processing results associated with all the plurality of simulated traffic objects (i.e., all the plurality of simulated traffic objects are processed). Further, the processing engine 112 may determine a trained model based on the plurality of samples. For example, the processing engine 112 may iteratively updating a plurality of preliminary feature weights until a difference between a simulated actual driving path and the simulated ideal driving path is larger than a similarity threshold for each of the plurality of samples.

In some embodiments, the plurality of feature weights may be adjusted based on test data. For example, the processing engine 112 may define a plurality of driving scenarios (similarly, each of which corresponds to various traffic information, environmental information, time information, geographical information, or the like, or any combination thereof) and direct a driver to actually drive a test vehicle (which has similar features with the vehicle) in the plurality of driving scenarios. For each of the plurality of features, the processing engine 112 may determine a plurality of candidate feature weights and select a target feature weight from the plurality of candidate feature weights based on test results. For example, for each of the plurality of candidate feature weights, the processing engine 112 may determine one or more features (e.g., smoothness, a distance between the test driving path and a nearest traffic object) associated with a test driving path of the test vehicle which is determined based on the candidate feature weight, and determine a score of the candidate feature weight based on the one or more features. Further, the processing engine 112 may select the target feature weight based on scores of the plurality of feature weights.

In 440, the processing engine 112 (e.g., the determination module 330) (e.g., the processing circuits of the processor 220) may determine a priority queue associated with the plurality of traffic objects based on a plurality of priority values, wherein the priority value is based on the plurality of feature weights and the feature values of each traffic object.

For example, take a specific traffic object as an example, the processing engine 112 may determine the priority value corresponding to the specific traffic object according to formula (8) below:

P=W^{type}·V_{T}+W^{position}·V_{P}+W^{distance}·V_{D}+W₁^{velocity}·V₁′+W₂^{velocity}·V₂′ (8)

where P refers to the priority value corresponding to the specific traffic object, W^{type} refers to the feature weight of the “type of the traffic object,” W^{position} refers to the feature weight of the “position of the traffic object,” w^{distance} refers to the feature weight of the “distance between the traffic object and the vehicle,” W₁^{velocity} refers to the feature weight of the “x-axis velocity of the traffic object,” W₂^{velocity} refers to the feature weight of the “y-axis velocity of the traffic object,” V₁′ refers to the feature value of the “x-axis velocity of the traffic object,” and V₂′ refers to the feature value of the “y-axis velocity of the traffic object.”

In some embodiments, the processing engine 112 may determine the priority queue based on the plurality of priority values corresponding to the plurality of traffic objects according to a predetermined order (e.g., an ascending order, a descending order).

In some embodiments, the processing engine 112 may further process the plurality of traffic objects based on the priority queue. For example, the processing engine 112 may predict probable behaviors associated with at least part of the plurality of traffic objects based on features of the at least part of the plurality of traffic objects. More descriptions regarding processing the plurality of traffic objects may be found elsewhere in the present disclosure (e.g., FIG. 6 and the descriptions thereof).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, as described in connection with operation 430, the plurality of feature weights may be determined based on a combination of an offline mode (e.g., based on predetermined rules or test data) and an on-line mode (e.g., by using a trained model). As another example, one or more other optional operations (e.g., a storing operation) may be added elsewhere in the process 400. In the storing operation, the processing engine 112 may store information and/or data (e.g., the feature values of the plurality of features of each traffic object, the feature weights corresponding to the plurality of features, the priority queue) associated with the plurality of traffic objects in a storage device (e.g., the storage 140) disclosed elsewhere in the present disclosure.

FIG. 5 is a schematic diagram illustrating an exemplary relation between a velocity of the vehicle and a velocity of a traffic object according to some embodiments of the present disclosure. As illustrated, 510 and 520 refer to traffic objects (e.g., other vehicles) within a predetermined range of a vehicle 502. The vehicle 502 is driving along lane 1 at a velocity v₀, the traffic object 510 is driving along lane 2 at a velocity v₁, and the traffic object 520 is turning right at a velocity v₂. It can be seen that an x-axis velocity of the vehicle 502 is 0 and a y-axis velocity of the vehicle 502 is v₀^{y} (which is equal to v₀); an x-axis velocity of the traffic object 510 is 0 and a y-axis velocity of the traffic object 510 is v₁^{y} (which is equal to v₁); and an x-axis velocity of the traffic object 520 is v₂^{x} and a y-axis velocity of the traffic object 520 is v₂^{y} (which can be determined based on v₂ and an angle θ between v₂ and x-axis).

Further, the processing engine 112 may determine feature values for the traffic object 510 and the traffic object 520 according to formula (4) and formula (5). For example, for the traffic object 510, the processing engine 112 may determine a feature value of the “x-axis velocity of the traffic object” as 0 and an absolute value of a feature value of the “y-axis velocity of the traffic object” as |v₁^{y}−v₀^{y}|. It can be seen that a direction of the y-axis velocity of the traffic object 510 and a direction of the y-axis velocity of the vehicle 502 are different, therefore, the feature value of the “y-axis velocity of the traffic object” is positive. For the traffic object 520, the processing engine 112 may determine an absolute value of a feature value of the “x-axis velocity of the traffic object” as |v₂^{x}| and an absolute value of a feature value of the “y-axis velocity of the traffic object” as |v₂^{y}−v₀^{y}|. It can be seen that an absolute value of the x-axis velocity of the traffic object 520 is higher than an absolute value (i.e., 0) of the x-axis velocity of the vehicle, therefore, the feature value of the “x-axis velocity of the traffic object” is negative; a direction of the y-axis velocity of the traffic object 520 and the direction of the y-axis velocity of the vehicle 502 are the same and it is assumed that an absolute value of the y-axis velocity of the traffic object 520 is less than an absolute value of the y-axis velocity of the vehicle 502, the feature value of the “y-axis velocity of the traffic object” may be positive.

For illustration purposes, the present disclosure takes a rectangular coordinate system as an example, it should be noted that the “velocity” can be expressed in any other coordinate system (e.g., a polar coordinate system, a spherical coordinate system), and accordingly the “velocity” can be decomposed in other forms.

FIG. 6 is a flowchart illustrating an exemplary process for determining a driving path according to some embodiments of the present disclosure. The process 600 may be executed by the autonomous driving system 100. For example, the process 600 may be implemented as a set of instructions stored in the storage ROM 230 or RAM 240. The processor 220 and/or the modules in FIG. 3 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIG. 6 and described below is not intended to be limiting.

In 610, as described in connection with FIG. 4, after determining the priority queue associated with the plurality of traffic objects, the processing engine 112 (e.g., the processing module) (e.g., the processing circuits of the processor 220) may obtain traffic conditions associated with the predetermined range of the vehicle. In some embodiments, the traffic conditions may include a road width, a road length, a road type (e.g., expressway, beltway, side road, flyover, one-way road, two-way road), traffic lane information (e.g., left-turn lane, right-turn lane, bus transit lane, bicycle lane), a traffic sign (e.g., a road indicator), traffic light information, sidewalk information, or the like, or any combination thereof.

In 620, the processing engine 112 (e.g., the processing module) (e.g., the processing circuits of the processor 220) may predict probable behaviors associated with at least part of the plurality of traffic objects based on features (e.g., historical moving information, a current location, a velocity) of the at least part of the plurality of traffic objects and the traffic conditions. As used herein, take a specific traffic object as an example, the probable behavior may refer to a probable status (which can be expressed as a moving path) of the specific traffic object within a predetermined time period from the current time point. The moving path may include moving information (e.g., a velocity, an acceleration, a moving action (e.g., a lane change action, a turn action)) associated with the traffic object. In some embodiments, the processing engine 112 may establish a model based on the features of the at least part of the plurality of traffic objects and the traffic conditions and predict the probable behaviors based on the model.

It should be noted that the autonomous driving system 100 is a real time or substantially real time system, which needs rapid calculation and reaction. Therefore, in order to ensure the normal operation of autonomous driving system 100, the processing associated with the plurality of traffic objects should be controlled within a predetermined processing time period. Accordingly, in some embodiments, the processing engine 112 may process at least part of the plurality of traffic objects one by one according to the priority queue within the predetermined processing time period. For example, it is assumed that the priority queue associated with the plurality of traffic objects is expressed as a sequence below:

[object A,object B,object C,object D . . . ] (9)

In this situation, the processing engine 112 may process the traffic objects one by one according to the sequence (e.g., A first, B secondly, C thirdly, and so on), and it is assumed that the processing of a traffic object H is just completed at the end of the predetermined processing time period, the processing engine 112 may stop the processing associated with the plurality of traffic objects and start subsequent operations, for example, determine a driving path for the vehicle based on processing results in 630.

In some embodiments, the processing engine 112 may select at least part (e.g., top 2, top 5, top 10, top 15, top 50) of the plurality of traffic objects based on the priority queue and process the at least part of the plurality of traffic objects in a parallel mode or a distributed mode within the predetermined processing time period. In some embodiments, the processing engine 112 may select to process the traffic objects each having a priority value that exceeds a certain predetermined threshold. In some embodiments, the selection of traffic objects can be a combined approach with a predetermined number (e.g., 5) and a threshold value. For example, the processing engine 112 may first select the traffic objects each having a priority value that is higher than a threshold value; and if the number of selected traffic objects is less that a predetermined number, then the processing engine 112 may select more traffic objects in the queue to reach the predetermined number, or choose not to make further selections. While the approach of reaching the predetermined number each time may allow a relatively stable processing sequence (i.e. each time the same or substantially same number of traffic objects are processed), the approach of not making further selections may allow for conservation of processing capacity, which can be used for other matters. As another example, the processing engine 112 may first select a predetermined number of traffic object from the priority queue, and then choose to not altering the processing, or choose to remove traffic objects from processing when their priority values are lower than a threshold value.

In 630, the processing engine 112 (e.g., the processing module) (e.g., the processing circuits of the processor 220) may determine a driving path for the vehicle based on the probable behaviors associated with the at least part of the plurality of traffic objects. In some embodiments, the processing engine 112 may determine a plurality of candidate driving paths based on driving information (e.g., a current location of the vehicle, a current velocity of the vehicle, a current acceleration of the vehicle, a defined destination) associated with the vehicle and the probable behaviors. Further, the processing engine 112 may select a target driving path from the plurality of candidate driving paths. More descriptions for determining the driving path may be found in International Application No. PCT/CN2017/092714 filed on Jul. 13, 2017 and International Application No. PCT/CN2018/______, entitled “SYSTEMS AND METHODS FOR DETERMINING DRIVING PATH IN AUTONOMOUS DRIVING,” filed on even date, the entire contents of which are incorporated herein by reference in their entirety.

In 640, the processing engine 112 (e.g., the transmission module) (e.g., the interface circuits of the processor 220) may transmit signals (e.g., electric signals) to one or more control components of the vehicle to direct the vehicle to follow the driving path. For example, the processing engine 112 may transmit electric signals to the steering device (e.g., the steering wheel) of the vehicle to adjust a driving direction of vehicle. As another example, the processing engine 112 may transmit electric signals to the accelerator to adjust a velocity of the vehicle.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing operations) may be added elsewhere in the process 600. In the storing operation, the processing engine 112 may store information and/or data (e.g., the probable behaviors) associated with the processing of the plurality of traffic objects in a storage device (e.g., the storage 140) disclosed elsewhere in the present disclosure.

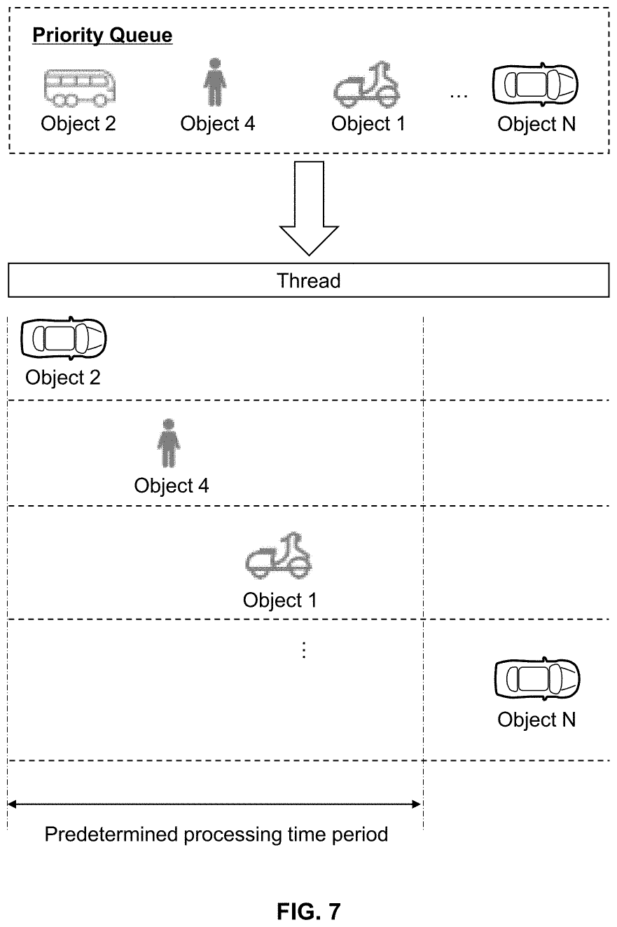

FIG. 7 is a schematic diagram illustrating an exemplary process for processing a plurality of traffic objects based on a priority queue according to some embodiments of the present disclosure. As illustrated, the priority queue includes object 2, object 4, object 1, . . . , object N which are ordered from high to low based on priority values. The processing engine 112 may process the plurality of traffic objects one by one through a single thread according to the priority queue, and at the end of the predetermined processing time period, the processing engine 112 may stop the processing and start subsequent operations, for example, determine a driving path for the vehicle based on the processing results.

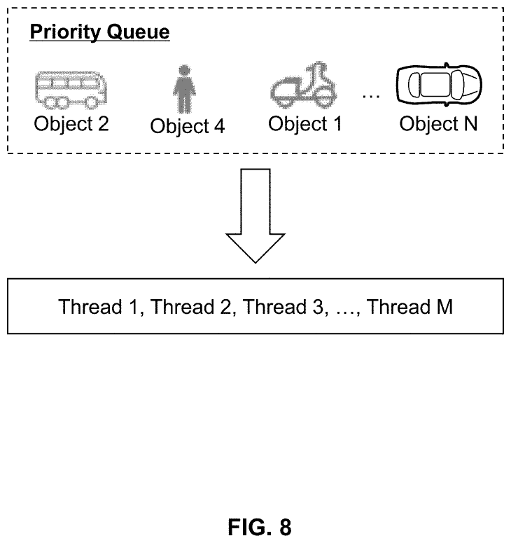

FIG. 8 is a schematic diagram illustrating an exemplary process for processing a plurality of traffic objects based on a priority queue in a parallel mode according to some embodiments of the present disclosure. As illustrated, the processing engine 112 may process the plurality of traffic objects through a plurality of threads according to the priority queue. For example, it is assumed that there are M threads, the processing engine 112 may select top M traffic objects based on the priority queue and process the M traffic objects by the M threads simultaneously. Further, after the processing of one or more of the M traffic objects is completed (i.e., corresponding thread(s) become(s) idle), the processing engine 112 may select one or more subsequent traffic objects based on the priority queue and process the one or more subsequent traffic objects through the one or more idle threads, until the end of the predetermined processing time period.

For illustration purposes, the present disclosure takes a parallel-thread mode as an example, it should be noted that the processing engine 112 may process the plurality of traffic objects in a distributed mode, in which the processing engine 112 may process the plurality of traffic objects through a plurality of computing nodes according to the priority queue.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for processing traffic objects, comprising:
at least one storage medium including a set of instructions; and
at least one processor in communication with the at least one storage medium, wherein when executing the set of instructions, the at least one processor is directed to cause the system to:
receive detection information associated with a plurality of traffic objects within a predetermined range of a vehicle;
extract feature values of a plurality of features of each of the plurality of traffic objects from the detection information;
obtain a plurality of feature weights corresponding to the plurality of features of each traffic object; and
determine a priority queue associated with the plurality of traffic objects based on a plurality of priority values, each corresponding to each traffic object, wherein the priority value is based on the plurality of feature weights and the feature values of each traffic object.

2. The system of claim 1, wherein the plurality of features of each of the plurality of traffic objects include a type of the traffic object, a position of the traffic object, a velocity of the traffic object, an acceleration of the traffic object, and a distance between the traffic object and the vehicle.

3. The system of claim 1, wherein the plurality of feature weights are determined based at least in part on a predetermined rule, statistical data, or machine learning.

4. The system of claim 1, wherein the plurality of feature weights are adjusted based on test data.

5. The system of claim 1, wherein the plurality of feature weights are associated with traffic information, environmental information, time information, geographical information, or any combination thereof.

6. The system of claim 1, wherein the at least one processor is directed to cause the further system to:
process the plurality of traffic objects based on the priority queue.

7. The system of claim 6, wherein to process the plurality of traffic objects based on the priority queue, the at least one processor is directed to cause the system to:
process at least part of the plurality of traffic objects one by one according to the priority queue within a predetermined processing time period.

8. The system of claim 6, wherein to process the plurality of traffic objects based on the priority queue, the at least one processor is directed to cause the system to:
select at least part of the plurality of traffic objects based on the priority queue; and
process the at least part of the plurality of traffic objects in a parallel mode or a distributed mode within a predetermined processing time period.

9. The system of claim 1, wherein the at least one processor is directed to cause the system further to:
obtain traffic conditions associated with the predetermined range of the vehicle;
predict probable behaviors associated with at least part of the plurality of traffic objects based on features of the at least part of the plurality of traffic objects and the traffic conditions; and
determine a driving path for the vehicle based on the probable behaviors associated with the at least part of the plurality of traffic objects.

10. The system of claim 9, wherein the at least one processor is directed to cause the system further to:
transmit signals to one or more control components of the vehicle to direct the vehicle to follow the driving path.

11. A method implemented on a computing device having at least one processor, at least one storage medium, and a communication platform connected to a network, the method comprising:
receiving detection information associated with a plurality of traffic objects within a predetermined range of a vehicle;
extracting feature values of a plurality of features of each of the plurality of traffic objects from the detection information;
obtaining a plurality of feature weights corresponding to the plurality of features of each traffic object; and
determining a priority queue associated with the plurality of traffic objects based on a plurality of priority values, each corresponding to each traffic object, wherein the priority value is based on the plurality of feature weights and the feature values of each traffic object.

12. The method of claim 11, wherein the plurality of features of each of the plurality of traffic objects include a type of the traffic object, a position of the traffic object, a velocity of the traffic object, an acceleration of the traffic object, and a distance between the traffic object and the vehicle.

13. The method of claim 11, wherein the plurality of feature weights are determined based at least in part on a predetermined rule, statistical data, or machine learning.

14. The method of claim 11, wherein the plurality of feature weights are adjusted based on test data.

15. The method of claim 11, wherein the plurality of feature weights are associated with traffic information, environmental information, time information, geographical information, or any combination thereof.

16. The method of claim 11, further comprising:
processing the plurality of traffic objects based on the priority queue.

17. The method of claim 16, wherein the processing of the plurality of traffic objects based on the priority queue includes:
processing at least part of the plurality of traffic objects one by one according to the priority queue within a predetermined processing time period.

18. The method of claim 16, wherein the processing of the plurality of traffic objects based on the priority queue includes:
selecting at least part of the plurality of traffic objects based on the priority queue; and
processing the at least part of the plurality of traffic objects in a parallel mode or a distributed mode within a predetermined processing time period.

19. The method of claim 11, further comprising:
obtaining traffic conditions associated with the predetermined range of the vehicle;
predicting probable behaviors associated with at least part of the plurality of traffic objects based on features of the at least part of the plurality of traffic objects and the traffic conditions; and
determining a driving path for the vehicle based on the probable behaviors associated with the at least part of the plurality of traffic objects.

20. (canceled)

21. A non-transitory computer readable medium, comprising executable instructions that, when executed by at least one processor, direct the at least one processor to perform a method, the method comprising:
receiving detection information associated with a plurality of traffic objects within a predetermined range of a vehicle;
extracting feature values of a plurality of features of each of the plurality of traffic objects from the detection information;
obtaining a plurality of feature weights corresponding to the plurality of features of each traffic object; and
determining a priority queue associated with the plurality of traffic objects based on a plurality of priority values, each corresponding to each traffic object, wherein the priority value is based on the plurality of feature weights and the feature values of each traffic object.
